(19) United States
(12) Patent Application Publication
(10) Pub. No.: US 2010/0275687 A1
(43) Pub. Date: Nov. 4, 2010

(54) HOUSING FOR A MEASURING EQUIPMENT AND MEASURING EQUIPMENT HAVING THE SAME

(75) Inventors: Seung-Chul Han, Asan-si (KR); Woo-Young Lim, Goyang-si (KR)

Correspondence Address: Jae Y. Park, Kile, Park, Reed & McManus, PLLC, 1200 New Hampshire Ave. NW, Suite 570, Washington, DC, 20036, US

(73) Assignee: KOH YOUNG TECHNOLOGY INC., Seoul (KR)

(21) Appl. No.: 12/771,348

(22) Filed: Apr. 30, 2010

(30) Foreign Application Priority Data
Apr. 30, 2009 (KR) 2009-0038570
Jan. 27, 2010 (KR) 2010-0007454

(51) Int. Cl. G01D 11/24

(52) U.S. Cl. 73/431

(57) ABSTRACT

A housing for a measuring equipment receiving a measurement apparatus includes a body, a predetermined area of which is open, a first door combined with the body to cover at least a portion of the open predetermined area of the body, and a second door combined with the body to cover at least a portion of the open predetermined area of the body. A display unit is installed on the second door to be rotated from a first face toward a second face. Thus, a space required to install the display unit may be reduced, and a viewing scope of the display unit may be increased.

### CROSS REFERENCE TO RELATED APPLICATION

This application claims priority from and the benefit of Korean Patent Applications No. 2009-38570, filed on Apr. 30, 2009, and No. 2010-7454, filed on Jan. 27, 2010, which are hereby incorporated by reference for all purposes as if fully set forth herein.

### BACKGROUND OF THE INVENTION

1. Field of the Invention

Exemplary embodiments of the present invention relate to a housing for a measuring equipment and a measuring equipment having the same. More particularly, exemplary embodiments of the present invention relate to a housing for a measuring equipment, on which a display unit is installed, and a measuring equipment having the same.

2. Discussion of the Background

Generally, a measuring equipment such as a three dimensional shape measurement apparatus includes a housing receiving a measurement apparatus, and a display unit is installed on the housing to monitor a measurement status.

In a conventional measuring equipment, a display unit is fixed to a housing, or installed on a protruding portion that protrudes from the housing.

In case that the display unit is fixed to the housing, the display unit is not rotatable according to a user's working position, the display unit cannot be viewed at various positions at which a user desires to work.

In case that the display unit is installed on a protruding portion that protrudes from a housing, the display unit may be configured to be rotatable according to a user's working position, but the protruding portion occupies a space corresponding to an amount by which the protruding portion protrudes from the housing. In order that the display unit is rotated in a wide angle, a protrusion length of the protruding portion should be sufficiently lengthened. In this case, a problem is incurred that a working space becomes small due to the space that the protruding portion occupies. Furthermore, the protruding portion always occupies the space not only in working but also in non-working, and thus a space becomes small and worker's injury may be incurred. In addition, when reducing the protrusion length for securing a space, a rotation angle becomes small, and thus the display unit cannot be viewed at various positions that a user desires.

### SUMMARY OF THE INVENTION

Exemplary embodiments of the present invention provide a housing for a measuring equipment capable of both widening a viewing angle of a display unit and securing a space.

Exemplary embodiments of the present invention also provide a measuring equipment having the above-mentioned housing.

Additional features of the invention will be set forth in the description which follows, and in part will be apparent from the description, or may be learned by practice of the invention.

An exemplary embodiment of the present invention discloses a housing for a measuring equipment receiving a measurement apparatus. The housing includes a body, a predetermined area of which is open, a first door combined with the body to cover at least a portion of the open predetermined area of the body, and a second door combined with the body to cover at least a portion of the open predetermined area of the body. A display unit is installed on the second door to be rotated from a first face of the second door toward a second face of the second door.

In an exemplary embodiment, the second door may include a first rotation plate that is first rotatable with respect to the body and a second rotation plate that is second rotatable with respect to the first rotation plate, the display unit being installed on a front face of the second rotation plate.

The second door may further include a first rotation combination part that is hinge-combined with the body to be first rotatable with respect to the body and a second rotation combination part that is hinge-combined with the first rotation plate to be second rotatable with respect to the first rotation plate.

The first rotation plate may be combined with the body to be rotatable with respect to the body from a location substantially in parallel with a front face of the body to a location substantially perpendicular to the front face of the body by at least about 90 degrees.

The display unit may be fixed to and combined with the second rotation plate to be rotatable with respect to the first rotation plate from a front face of the first rotation plate to a rear face of the first rotation plate.

During opening the second door, the first rotation plate may be first rotated in a first rotation direction, and the second rotation plate may be second rotated in a second rotation direction that is different from the first rotation direction. During closing the second door, the first rotation plate may be first rotated in the second rotation direction, and the second rotation plate may be second rotated in the first rotation direction.

For example, when the first door and the second door are closed, the open predetermined area of the body may be closed.

The first door may be substantially vertically moved to close or open at least a portion of the open predetermined area, and the second door may be substantially parallelly moved to close or open at least a portion of the open predetermined area.

In another exemplary embodiment of the present invention discloses a measuring equipment. The measuring equipment includes a measurement apparatus, a housing receiving a measurement apparatus, and a display unit. The housing includes a body, a predetermined area of which is open, a first door combined with the body to cover at least a portion of the open predetermined area of the body, and a second door combined with the body to cover at least a portion of the open predetermined area of the body. The second door includes a first rotation plate that is first rotatable with respect to the body and a second rotation plate that is second rotatable with respect to the first rotation plate. The display unit is installed on a front face of the second rotation plate of the second door.

The first door may be substantially vertically moved to close or open at least a portion of the open predetermined area, and the second door may be substantially parallelly moved to close or open at least a portion of the open predetermined area.

The first rotation plate may be combined with the body to be rotatable with respect to the body from a location substantially in parallel with a front face of the body to a location substantially perpendicular to the front face of the body by at least about 90 degrees, and the display unit may be fixed to and combined with the second rotation plate to be rotatable with respect to the first rotation plate from a front face of the first rotation plate to a rear face of the first rotation plate.

In an exemplary embodiment, the display unit may include a display part combined with the second door to display an image, an input part externally receiving information and a combination part combining the display part and the input part with each other, so that the input part is rotatable with respect to the display part.

The display unit may further include a location control part disposed at a rear side of the display part to control at least one of a height and an inclination angle of the display part.

During opening the second door, the first rotation plate may be first rotated in a first rotation direction, and the second rotation plate may be second rotated in a second rotation direction that is different from the first rotation direction. During closing the second door, the first rotation plate may be first rotated in the second rotation direction, and the second rotation plate may be second rotated in the first rotation direction.

In still another exemplary embodiment of the present invention discloses a housing for a measuring equipment receiving a measurement apparatus. The housing includes a body, a predetermined area of which is open, a display installation part combined with the body, a display unit being installed on the display installation part to be rotated from a first face of the display installation part toward a second face of the display installation part and a door combined with the body to cover at least a portion of the open predetermined area of the body.

In an exemplary embodiment, the display installation part includes a first rotation plate that is first rotatable with respect to the body and a second rotation plate that is second rotatable with respect to the first rotation plate. The display unit may be installed on a front face of the second rotation plate.

A stepped portion may be formed at the door to form a receiving space so that the display installation part is disposed in the receiving space.

According to the above, the display unit is installed on the front face of the door or the display installation part of the housing for the measuring equipment, and the display unit installed on the door or the display installation part is rotated from the front face toward the rear face, thereby greatly reducing a space required to install the display unit.

In addition, the door or the display installation part are doubly rotatable with respect to the body of the housing, to thereby widening a rotation angle of the display unit 200 and also reducing a space in which the display unit is installed.

In addition, a worker, who operates measurement, inspection, etc. by using the measurement apparatus, may easily view the display unit and the worker may also easily view the display unit even while the worker puts his head into the housing. Thus, a viewing scope of the display unit may be increased.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view illustrating a measuring equipment according to an exemplary embodiment of the present invention.

FIG. 2 is a perspective view illustrating the measuring equipment illustrated in FIG. 1, a first door of a housing of which is open.

FIG. 3 is a perspective view illustrating the measuring equipment illustrated in FIG. 1, the first door and a second door of the housing of which is open.

FIG. 4 is an enlarged perspective view illustrating the second door and a display unit illustrated in FIG. 1.

FIG. 5 is a perspective view backwardly illustrating the second door and the display unit illustrated in FIG. 4.

FIG. 6 is an enlarged perspective view illustrating the second door and the display unit illustrated in FIG. 3.

FIG. 7 is a perspective view backwardly illustrating the second door and the display unit illustrated in FIG. 6.

FIGS. 8 and 9 are schematic views illustrating a viewing scope of the display unit illustrated in FIGS. 4 and 5.

FIG. 10 is a perspective view illustrating a detail structure of the display unit illustrated in FIG. 4.

FIG. 11 is an exploded perspective view illustrating a detail structure of the display unit illustrated in FIG. 4.

FIG. 12 is a perspective view illustrating a portion of a measuring equipment according to another exemplary embodiment of the present invention.

### DETAILED DESCRIPTION OF THE ILLUSTRATED EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a housing for a measuring equipment and a measuring equipment having the housing according to an exemplary embodiment of the present invention will be described with reference to the accompanying drawings.

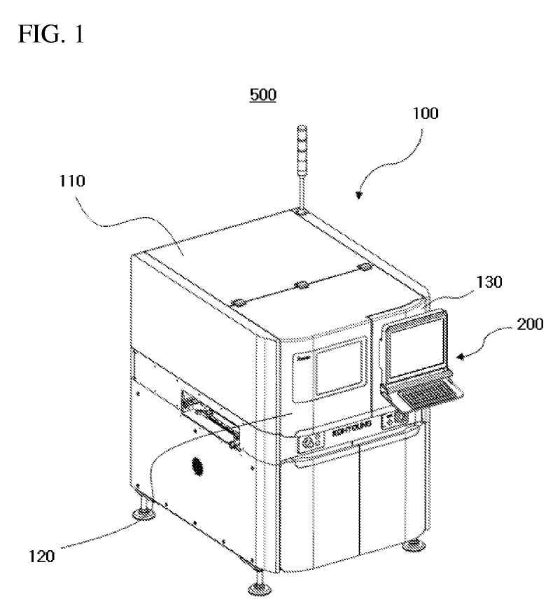

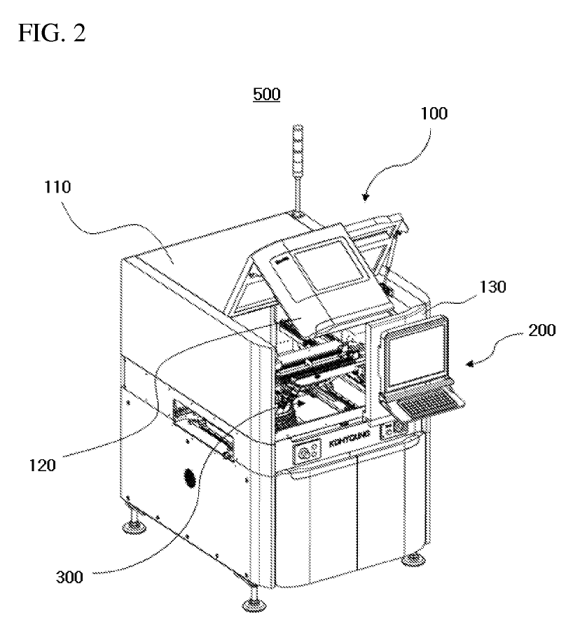

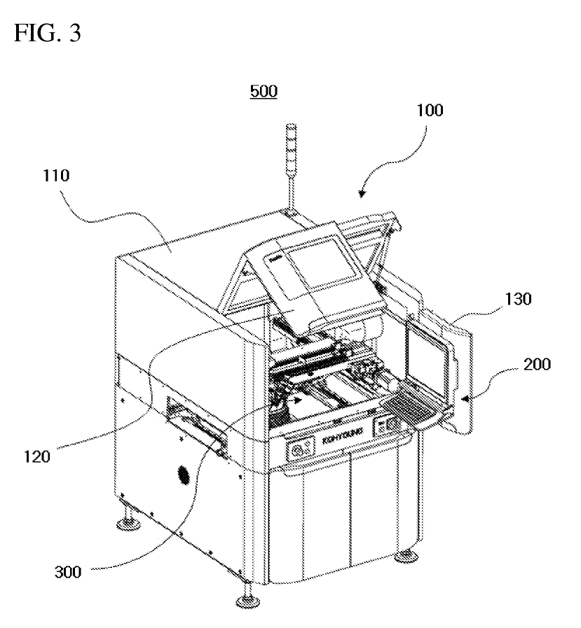

FIG. 1 is a perspective view illustrating a measuring equipment according to an exemplary embodiment of the present invention. FIG. 2 is a perspective view illustrating the measuring equipment illustrated in FIG. 1, a first door of a housing of which is open. FIG. 3 is a perspective view illustrating the measuring equipment illustrated in FIG. 1, the first door and a second door of the housing of which is open.

Referring to FIGS. 1 to 3, a measuring equipment 500 according to an exemplary embodiment of the present invention includes a housing 100, a display unit 200 and a measurement apparatus 300.

The housing 100 receives the measurement apparatus 300. The housing 100 includes a body 110, a first door 120 and a second door 130.

A predetermined area of the body 110 is open. The body 110 may have, for example, roughly a hexahedron shape as shown in FIGS. 1 to 3, and the predetermined area may be open for a worker to operate the measurement apparatus 300 at a front side of the hexahedron shape. For example, when the measurement apparatus 300 corresponds to a three dimensional shape measurement apparatus, a measurement target, for example, such as a printed circuit board (PCB) may be installed or separated through the open predetermined area.

The first door 120 is combined with the body 110. The first door 120 covers at least a portion of the open predetermined area, for example, a left portion of a front face and a portion of an upper face adjacent to the front face as shown in FIG. 1. The first door 120 may be hinge-combined with, for example, the upper face of the body 110 to be substantially vertically open or closed. A worker may operate the measurement apparatus 300 after opening the first door 120, and may close the first door 120 after finalizing the work.

The second door 130 is combined with the body 110. The second door 130 covers at least a portion of the open predetermined area, for example, a right portion of the front face. Similarly to the first door 120, a worker may operate the measurement apparatus 300 after opening the second door 130, and may close the second door 130 after finalizing the work. The second door 130 may be doubly rotated with respect to the body 110. Thus, a worker may easily view the display unit 200 that is installed on the second door 130. The detail structure and the rotation method for the double rotation of the second door 130 will be described later.

The display unit 200 is installed on a front face of the second door 130. For example, the display unit 200 may be connected to the measurement apparatus 300 to monitor a measurement status.

The measurement apparatus 300 may include various measurement apparatuses. For example, the measurement apparatus 300 may include a three dimensional shape measurement apparatus for inspecting a printed circuit board (PCB).

Hereinafter, the detail structure and the rotation method for the double rotation of the second door 130 will be described in detail with reference to the accompanying drawings.

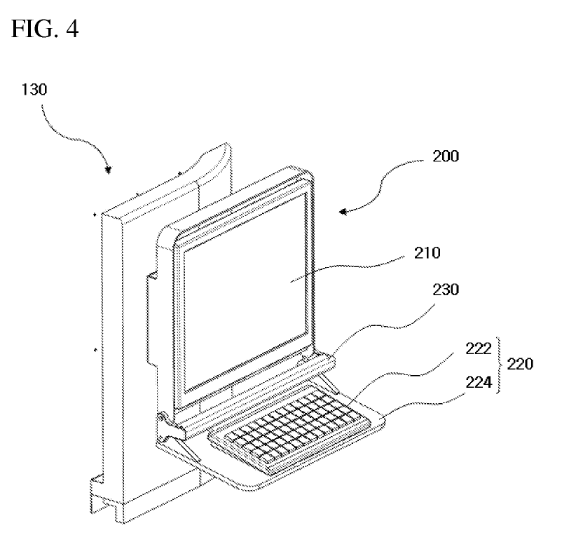

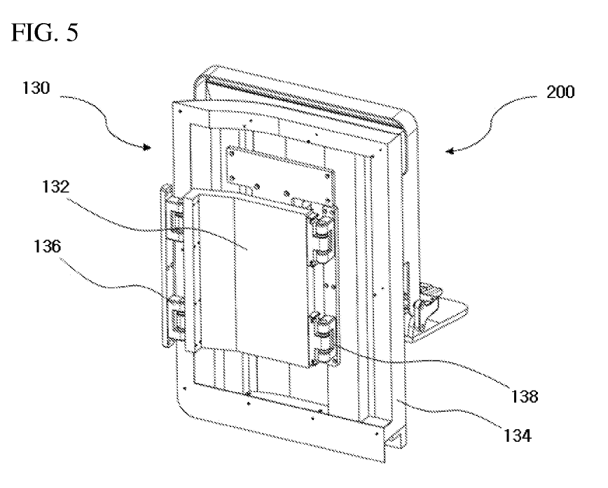

FIG. 4 is an enlarged perspective view illustrating the second door and the display unit illustrated in FIG. 1. FIG. 5 is a perspective view backwardly illustrating the second door and the display unit illustrated in FIG. 4. FIGS. 4 and 5 illustrate the second door 130 and the display unit 200, in which the second door 130 is closed as shown in FIG. 1.

Referring to FIGS. 1, 4 and 5, the second door 130 includes a first rotation plate 132 and a second rotation plate 134.

The first rotation plate 132 is formed to be first rotatable with respect to the body 110, and the second rotation plate 134 is formed to be second rotatable with respect to the first rotation plate 132. The display unit 200 is installed on a front face of the second rotation plate 134. For example, as shown in FIGS. 1 and 4, when the second door 130 is closed, the second rotation plate 134 is externally exposed, and the first rotation plate 132 is not externally exposed. In addition, when the first door 120 and the second door 130 are closed, the open predetermined area of the body 110 may be closed.

For example, the first rotation plate 132 is combined with the body 110 to be rotatable with respect to the body 110 from a location substantially in parallel with the front face of the body 110 to a location substantially perpendicular to the front face of the body 110 by at least about 90 degrees. The display unit 200 is fixed to and combined with the second rotation plate 134 to be rotatable with respect to the first rotation plate 132 from a front face of the first rotation plate 132 to a rear face of the first rotation plate 132.

In an exemplary embodiment, the second door 130 may further include a first rotation combination part 136 and a second rotation combination part 138, which have a hinge-combination type. The first rotation combination part 136 is hinge-combined with the body 110 to be first rotatable with respect to the body 110 that is fixed, and the second rotation combination part 138 is hinge-combined with the first rotation plate 132 to be second rotatable with respect to the first rotation plate 132.

The detail structure of the second door 130 will be described in detail with reference to the accompanying drawings, in case that the first rotation plate 132 is rotated by about 90 degrees and the second rotation plate 134 is rotated by about 180 degrees.

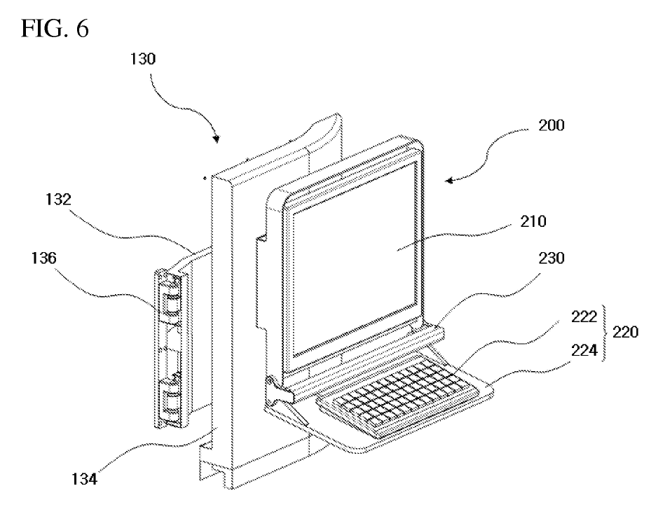

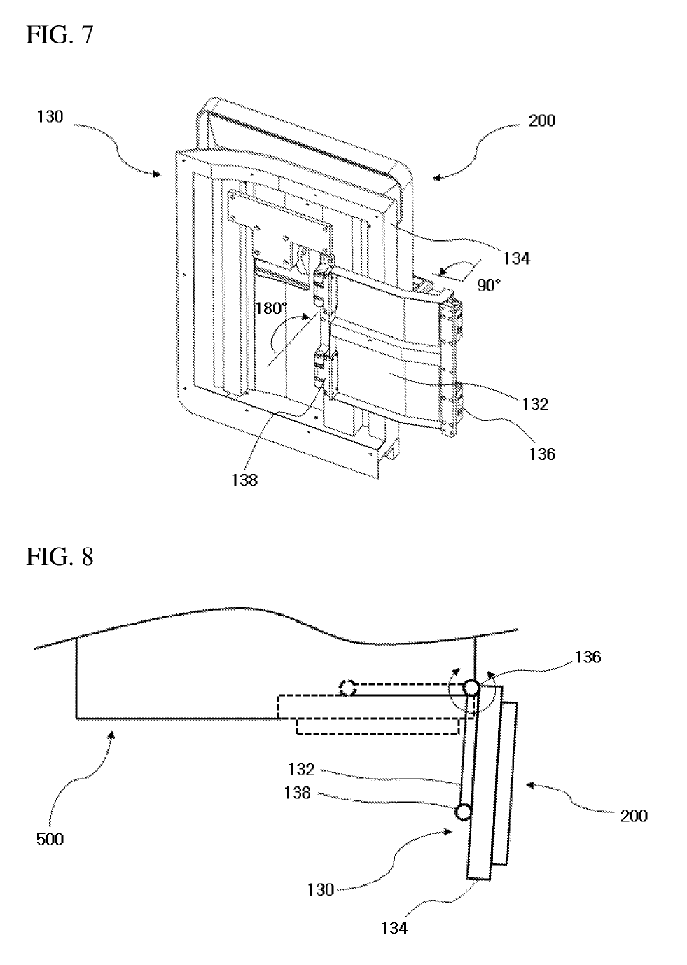

FIG. 6 is an enlarged perspective view illustrating the second door and the display unit illustrated in FIG. 3. FIG. 7 is a perspective view backwardly illustrating the second door and the display unit illustrated in FIG. 6. FIGS. 6 and 7 illustrate the second door 130 and the display unit 200, in which the second door 130 is open and the display unit 200 is rotated to be toward a center as shown in FIG. 3.

Referring to FIGS. 3, 6 and 7, the first rotation plate 132 is rotated with respect to the body 110 by about 90 degrees, and the second rotation plate 134 is rotated with respect to the first rotation plate 132 by about 180 degrees.

For example, during opening the second door 130, the first rotation plate 132 may be first rotated in a first rotation direction, and the second rotation plate 134 may be second rotated in a second rotation direction that is different from the first rotation direction. During closing the second door 130, the first rotation plate 132 is first rotated in the second rotation direction, and the second rotation plate 134 is second rotated in the first rotation direction. In FIGS. 6 and 7, the first rotation direction of the first rotation plate 132 is counterclockwise, and the second rotation direction of the second rotation plate 134 is clockwise.

Accordingly, a worker may operate the measurement apparatus 300 after opening the second door 130, and view the display unit 200.

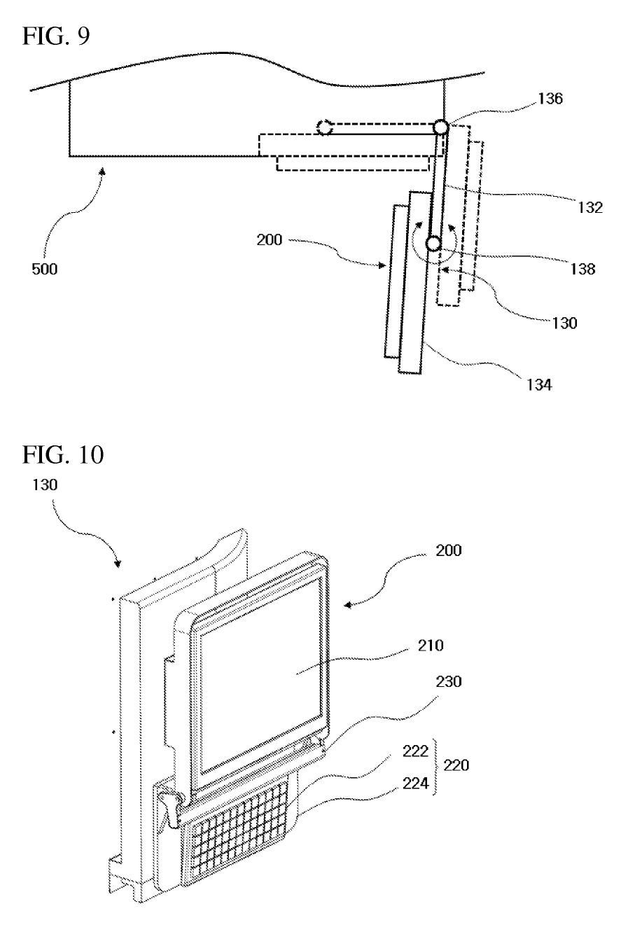

FIGS. 8 and 9 are schematic views illustrating a viewing scope of the display unit illustrated in FIGS. 4 and 5. FIGS. 8 and 9 correspond to a partial plan views illustrating the measuring equipment 500 when upwardly viewing the measuring equipment 500.

Referring to FIG. 8, during opening the second door 130, the first rotation plate 132 may be first rotated.

The first rotation plate 132 may be determined, for example, by shapes of the first and second rotation plates 132 and 134 and combination method of the body 110 (refer to FIGS. 1 to 3) and the first rotation plate 132. For example, the first rotation plate 132 may be rotated from about 0 degree to about 180 degrees. In FIG. 5, the first rotation plate 132 is rotatable from about 0 degree to about 90 degrees due to the combination method of the first rotation plate 132 and the body 110.

Since the display unit 200 is located at a side of the second rotation plate 134 so that the second rotation plate 134 is between the first rotation plate 132 and the display unit 200, a viewer of the display unit 200 may view the display unit 200 at positions from the front of the measuring equipment 500 to the right of the measuring equipment 500. However, when a worker are operating the measurement apparatus 300 (refer to FIGS. 2 and 3) disposed within the measuring equipment 500, the second door 130 is required to be open enough for the worker to operate the measurement apparatus 300. Thus, an actual viewing scope of the display unit 200 may be in a range corresponding to a rotation angle from about 90 degrees to about 180 degrees of the first rotation plate 132. In this case, the worker may not easily view the display unit 200 in operating the measurement apparatus 300.

Referring to FIG. 9, the second rotation plate 134 is second rotatable with respect to the first rotation plate 132.

The second rotation plate 134 may be determined, for example, by shapes and combination method of the first and second rotation plates 132 and 134. For example, the second rotation plate 134 may be rotated from about 0 degree to about 180 degrees.

As shown in FIG. 9, the display unit 200 is viewable in a direction opposite to the viewing direction in FIG. 6 by the second rotation of the second rotation plate 134. In addition, when a rotation angle of the second rotation is controlled according to a viewer's position, the display unit 200 may be viewable at most position of the front of the measuring equipment 500. Thus, for example, an actual viewing scope of the display unit 200, in a status that the first rotation plate 132 is rotated by about 90 degrees, may be in a range corresponding to a rotation angle with which the first rotation plate 132 is rotated by about 0 degree to about 180 degrees. Hence, even though the second door 130 is open enough for a worker to operate the measurement apparatus 300 (refer to FIGS. 2 and 3) disposed within the measuring equipment 500, the worker may easily view the display unit 200 in operating the measurement apparatus 300, and other viewer may easily view the display unit 200.

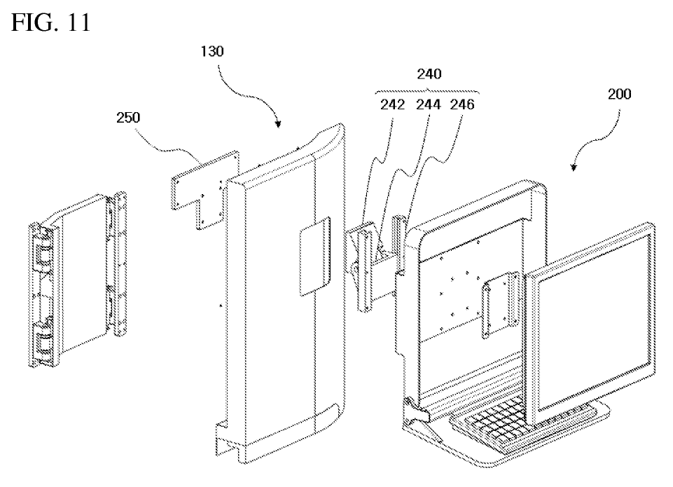

FIG. 10 is a perspective view illustrating a detail structure of the display unit illustrated in FIG. 4. FIG. 11 is an exploded perspective view illustrating a detail structure of the display unit illustrated in FIG. 4.

Referring to FIGS. 4, 10 and 11, the display unit 200 may include, in an exemplary embodiment, a display part 210, an input part 220 and a combination part 230.

The display part 210 displays an image, and may include, for example, a liquid crystal display device.

The input part 220 externally receives information. In an exemplary embodiment, the input part 220 may include a keyboard 222 directly receiving information and a support portion 224 supporting the keyboard 222. For example, the keyboard 222 and the support portion 224 may be integrally formed.

The combination part 230 combines the display part 210 and the input part 220. The combination part 230 may combines the display part 210 and the input part 220 so that the input part 220 is rotatable with respect to the display part 210. Thus, when the second door 130 is closed, as shown in FIG. 10, the input part 220 may be downwardly put, such that a space that the display unit 200 occupies may be effectively reduced.

The display unit 200 may further include a location control part 240 and a fixing piece 250.

The location control part 240 is disposed at a rear side of the display part 210, to control at least one of a height and an inclination angle of the display part 210. In an exemplary embodiment, the location control part 240 may include, as shown in FIG. 11, a fixing body 242, an inclination control body 244 and a slide guide 246.

The fixing body 242 is connected to the fixing piece 250 to combine the display unit 200 with the second door 130.

The inclination control body 244 is hinge-combined with the fixing body 242 to control the inclination angle of the display part 210.

The slide guide 246 is combined with the inclination control body 244 to guide the inclination control body 244 so that the inclination control body 244 may vertically slide, to thereby control the height of the display part 210.

The fixing piece 250 combines the second door 130 with the display unit 200 combined with the location control part 240.

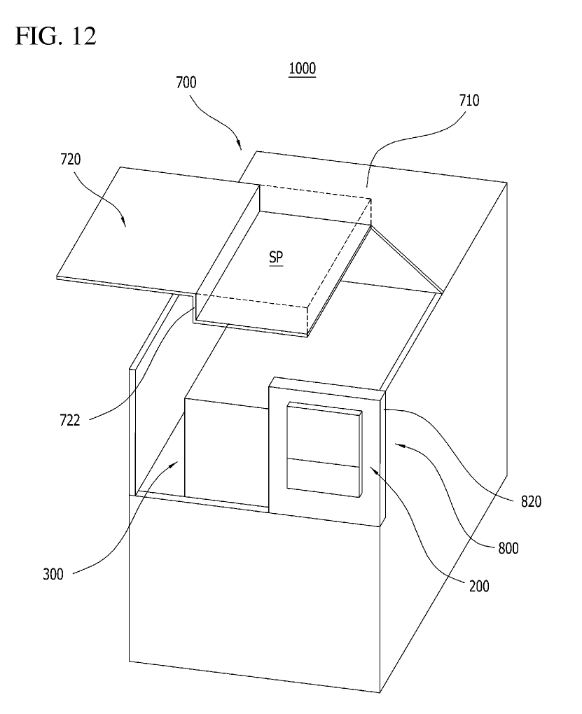

FIG. 12 is a perspective view illustrating a portion of a measuring equipment according to another exemplary embodiment of the present invention. The measuring equipment illustrated in FIG. 12, is substantially the same as the measuring equipment illustrated in FIGS. 1 through 11 except that the first and second doors form one door, and the display unit is installed on a display installation part formed separately from the door. Thus, any further description will be omitted.

Referring to FIG. 12, a measuring equipment 1000 according to another exemplary embodiment of the present invention includes a housing 700, a display installation part 800 and a measurement apparatus 300.

The housing 700 includes a body 710 and a door 720.

The body 710 is substantially the same as the body 110 illustrated in FIGS. 1 to 3. Thus, any further description will be omitted.

The door 720, as shown in FIG. 12, has a shape, in which the first door 120 illustrated in FIGS. 1 to 3 extends to the second door 130. Thus, the door 720 may cover the area the second door 130 covers in addition to the area the first door 120 covers in FIGS. 1 to 3,

A receiving space SP may be formed in the door 720 so that the display installation part 800 may be disposed in the receiving space SP. The receiving space SP may be formed so that the display unit 200 illustrated in FIGS. 1 through 11, in addition to the display installation part 800, may be disposed in the receiving space SP. In FIG. 12, the receiving space SP corresponds to a space indicated in a dotted line.

The receiving space SP may be formed in various methods. In an exemplary embodiment, as shown in FIG. 12, a stepped portion 722 may be formed at the door 720 corresponding to the receiving space SP. In FIG. 12, the door 720 is open, but in case that the door 720 is closed, the door 720 is first closed, and thereafter the display installation part 800 may be disposed in the receiving space SP.

The display installation part 800 is combined with the body 710, and includes a first rotation plate (not shown) that is first rotatable with respect to the body 710 and a second rotation plate 820 that is second rotatable with respect to the first rotation plate. The display unit 200 is installed on a front face of the second rotation plate 820. The first rotation plate and the second rotation plate 820 are operated with substantially the same principle and substantially the same structure as the first rotation plate 132 and the second rotation plate 134 illustrated in FIGS. 5 to 9. Thus, any further description will be omitted.

According to the present invention, the display unit 200 is installed on the front face of the door 130 or the display installation part 800 of the housing 100 for the measuring equipment 500, and the display unit 200 installed on the door 130 or the display installation part 800 is rotated from the front face toward the rear face, thereby greatly reducing a space required to install the display unit 200.

In addition, the door 130 or the display installation part 800 are doubly rotatable with respect to the body 110 or 710 of the housing 100 or 700, to thereby widening a rotation angle of the display unit 200 and also reducing a space in which the display unit 200 is installed.

In addition, a worker, who operates measurement, inspection, etc. by using the measurement apparatus 300, may easily view the display unit 200 and the worker may also easily view the display unit 200 even while the worker puts his head into the housing 100. Thus, a viewing scope of the display unit 200 may be increased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A housing for a measuring equipment receiving a measurement apparatus, comprising:
a body, a predetermined area of which is open;
a first door combined with the body to cover at least a portion of the open predetermined area of the body; and
a second door combined with the body to cover at least a portion of the open predetermined area of the body, a display unit being installed on the second door to be rotated from a first face toward a second face.

2. The housing of claim 1, wherein the second door comprises:
a first rotation plate that is first rotatable with respect to the body; and
a second rotation plate that is second rotatable with respect to the first rotation plate, the display unit being installed on a front face of the second rotation plate.

3. The housing of claim 2, wherein the second door further comprises:
a first rotation combination part that is hinge-combined with the body to be first rotatable with respect to the body; and
a second rotation combination part that is hinge-combined with the first rotation plate to be second rotatable with respect to the first rotation plate.

4. The housing of claim 2, wherein the first rotation plate is combined with the body to be rotatable with respect to the body from a location substantially in parallel with a front face of the body to a location substantially perpendicular to the front face of the body by at least about 90 degrees.

5. The housing of claim 2, wherein the display unit is fixed to and combined with the second rotation plate to be rotatable with respect to the first rotation plate from a front face of the first rotation plate to a rear face of the first rotation plate.

6. The housing of claim 2, wherein during opening the second door, the first rotation plate is first rotated in a first rotation direction, and the second rotation plate is second rotated in a second rotation direction that is different from the first rotation direction, and
wherein during closing the second door, the first rotation plate is first rotated in the second rotation direction, and the second rotation plate is second rotated in the first rotation direction.

7. The housing of claim 1, wherein when the first door and the second door are closed, the open predetermined area of the body is closed.

8. The housing of claim 1, wherein the first door is substantially vertically moved to close or open at least a portion of the open predetermined area, and the second door is substantially parallelly moved to close or open at least a portion of the open predetermined area.

9. A measuring equipment comprising:
a measurement apparatus;
a housing receiving a measurement apparatus, comprising:
a body, a predetermined area of which is open;
a first door combined with the body to cover at least a portion of the open predetermined area of the body; and
a second door combined with the body to cover at least a portion of the open predetermined area of the body, the second door comprising a first rotation plate that is first rotatable with respect to the body and a second rotation plate that is second rotatable with respect to the first rotation plate; and
a display unit installed on a front face of the second rotation plate of the second door.

10. The measuring equipment of claim 9, wherein the first door is substantially vertically moved to close or open at least a portion of the open predetermined area, and the second door is substantially parallelly moved to close or open at least a portion of the open predetermined area.

11. The measuring equipment of claim 9, wherein the first rotation plate is combined with the body to be rotatable with respect to the body from a location substantially in parallel with a front face of the body to a location substantially perpendicular to the front face of the body by at least about 90 degrees, and the display unit is fixed to and combined with the second rotation plate to be rotatable with respect to the first rotation plate from a front face of the first rotation plate to a rear face of the first rotation plate.

12. The measuring equipment of claim 9, wherein the display unit is combined with the second door, the display unit comprising:
a display part displaying an image;
an input part externally receiving information; and
a combination part combining the display part and the input part with each other, so that the input part is rotatable with respect to the display part.

13. The measuring equipment of claim 12, wherein the display unit further comprises a location control part disposed at a rear side of the display part to control at least one of a height and an inclination angle of the display part.

14. The measuring equipment of claim 9, wherein during opening the second door, the first rotation plate is first rotated in a first rotation direction, and the second rotation plate is second rotated in a second rotation direction that is different from the first rotation direction, and
wherein during closing the second door, the first rotation plate is first rotated in the second rotation direction, and the second rotation plate is second rotated in the first rotation direction.

15. A housing for a measuring equipment receiving a measurement apparatus, comprising:
a body, a predetermined area of which is open;
a display installation part combined with the body, a display unit being installed on the display installation part to be rotated from a first face toward a second face; and
a door combined with the body to cover at least a portion of the open predetermined area of the body.

16. The housing of claim 15, wherein the display installation part comprises:
a first rotation plate that is first rotatable with respect to the body; and
a second rotation plate that is second rotatable with respect to the first rotation plate, the display unit being installed on a front face of the second rotation plate.

17. The housing of claim 16, wherein a stepped portion is formed at the door to form a receiving space so that the display installation part is disposed in the receiving space.
